(19) United States
(12) Patent Application Publication
(10) Pub. No.: US 2009/0009620 A1
(43) Pub. Date: Jan. 8, 2009

(54) VIDEO CAMERA AND EVENT RECORDING METHOD

(75) Inventor: Yoshihisa Nozawa, Hachioji-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/147,801

(22) Filed: Jun. 27, 2008

(30) Foreign Application Priority Data
Jun. 29, 2007 (JP) 2007-173418

(51) Int. Cl. H04N 5/228

(52) U.S. Cl. 348/222.1; 348/E05.031

(57) ABSTRACT

According to one embodiment, the video camera includes an operation unit which performs a variety of input operations, a video shooting unit which performs video shooting, a recording unit which records video data obtained from the video shooting unit in a hard disk, and a GPS processing unit which determines a date and time. The video camera further includes an event information processing unit which creates typical event data including a variety of events by using a birthday input from the operation unit as a starting point and registers the typical event data in a database, selects events for at least the date and time of video shooting, as event candidates, from the typical event data registered in the database, forecast the most appropriate candidate by narrowing down the event candidates, and records the most appropriate candidate in the hard disk as an event associated with the video data.

### CROSS-REFERENCE TO RELATED APPLICATIONS

This application is based upon and claims the benefit of priority from Japanese Patent Application No. 2007-173418, filed Jun. 29, 2007, the entire contents of which are incorporated herein by reference.

### BACKGROUND

1. Field

One embodiment of the present invention relates to a video camera having a clock function, and in particular, relates to a video camera and an event recording method for recording an event associated with video data.

2. Description of the Related Art

Recently, video cameras intended for home use are significantly becoming popular. There is also a type of video camera which stores all video data obtained by repeated shootings in a hard disk. Most users purchase a video camera mainly for recording their child's growth. Therefore, it is desirable that the scene of their interest can be quickly retrieved from the hard disk and replayed.

Conventionally, it is proposed to record the date, time and event in association with video data at a time of shooting, as an index that makes retrieving easy (see, for example, Jpn. Pat. Appln. KOKAI Publication No. 9-98323). Further, the location of shooting is also recordable if a GPS function is provided in the video camera.

Although the abovementioned date and time and the location of shooting may be recorded automatically, the event requires confirmation on the replaying display and editing of the event name to be recorded in association with the video data. Further, the recording of the event needs to be performed for each shooting, even if the event is held annually, such as athletics meets. Users tend not to perform such event recording which is burdensome. In addition, since enormous amounts of video data can be stored in a hard disk, users consume time for retrieving a scene of interest.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram showing the circuit configuration of a video camera according to an embodiment of the present invention;

FIG. 2 is an exemplary flowchart showing a process of a birthday setting mode performed by an event information processing unit shown in FIG. 1;

FIG. 3 is an exemplary flowchart showing a process of a video shooting mode performed by the event information processing unit shown in FIG. 1; and

FIG. 4 is an exemplary flowchart showing a process of an event setting mode performed by the event information processing unit shown in FIG. 1.

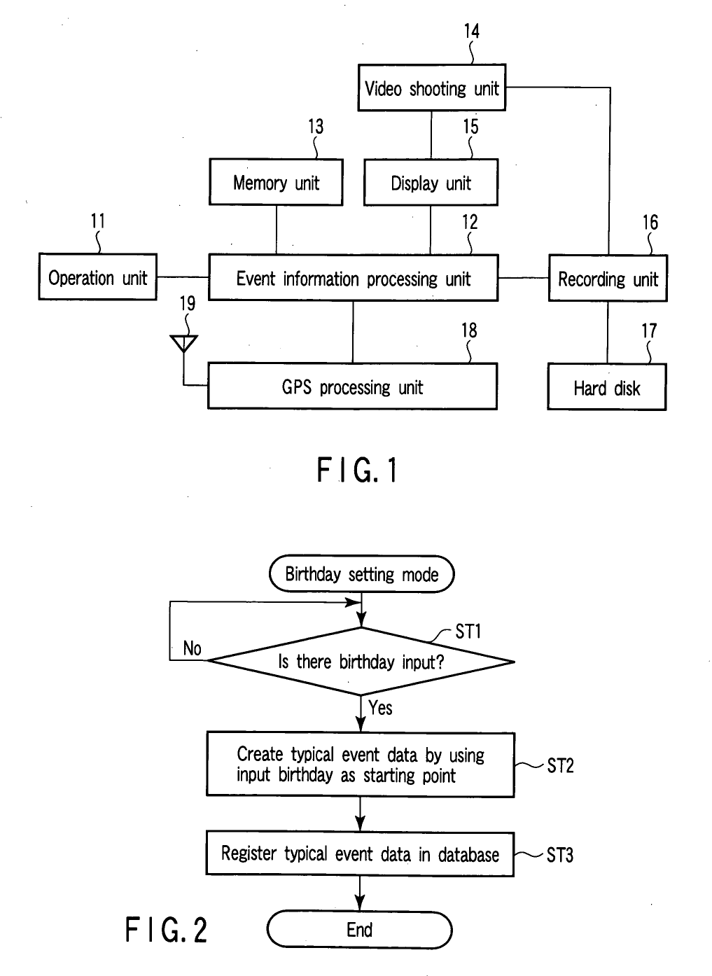

### DETAILED DESCRIPTION

Various embodiments according to the invention will be described with reference to the accompanying drawings.

According to an embodiment of the present invention, there is provided a video camera comprising: an operation unit which performs a variety of input operations; a video shooting unit which performs video shooting; a recording unit which records video data obtained from the video shooting unit in a recording medium; a clock unit which determines a date and time; and an event information processing unit which creates typical event data including a variety of events by using a birthday input from the operation unit as a starting point, registers the typical event data in a database, selects events for at least the date and time of video shooting, as event candidates, from the typical event data registered in the database, forecasting a most appropriate candidate by narrowing down the event candidates, and recording the most appropriate candidate in the recording medium as an event associated with the video data.

According to another embodiment of the present invention, there is provided an event recording method of a video camera which comprises an operation unit which performs a variety of input operations, a video shooting unit which performs video shooting, a recording unit which records video data obtained from the video shooting unit in a recording medium, and a clock unit which determines a date and time, the method comprising: creating typical event data including a variety of events by using a birthday input from the operation unit as a starting point; registering the typical event data in a database; selecting events for at least the date and time of video shooting, as event candidates, from the typical event data registered in the database; forecasting a most appropriate candidate by narrowing down the event candidates; and recording the most appropriate candidate in the recording medium as an event associated with the video data.

With the video camera and the event recording method, the typical event data including a variety of events is created by using a birthday input from the operation unit as a starting point and registered in the database. Events for at least the date and time of video shooting are selected, as event candidates, from the typical event data registered in the database. Further, the most appropriate candidate is forecasted by narrowing down the event candidates, and recorded in the recording medium as an event associated with the video data. Namely, the event can be recorded without a burden. There is a case that the event which is actually recorded is inappropriate. In this case, the user may revise the record of the event as needed. However, since the total number of inappropriate events is relatively small, the user does not have difficulty in finding a scene of interest without taking time even when the revision is not performed.

A video camera according to an embodiment of the present invention will be explained below. The video camera includes an operation unit 11 which performs a variety of input operations for one's child's birthday, a place of residence, a specific spot and the like, an event information processing unit 12 which performs processing of event information, a memory unit 13 which has a database for use in the processing of the event information, a video shooting unit 14 which performs video shooting, a display unit 15 which displays an object image together with a variety of information including an event at the time of shooting, a recording unit 16 which performs recording of video data obtained from the video shooting unit 14, a hard disk 17 serving as a recording medium which accumulates the video data recorded by the recording unit 16, a GPS processing unit 18 which performs a processing of GPS signals from GPS satellites to determine the date and time of shooting as a clock unit and examine the relation between the current location for shooting and the place of residence, and a GPS antenna 19 which receives the GPS signals. The event information processing unit 12 creates typical event data including a variety of events by using a birthday input from the operation unit 11 as a starting point, registers the typical event data in the database, selects events for at least each of the date and time of video shooting and the current location, as event candidates, from the typical event data registered in the database, and forecasts the most appropriate candidate by narrowing down the event candidates based on the lapse of days from the birthday and the distance between the place of residence and the shooting location, and records the most appropriate candidate in the hard disk 17, that is the recording medium, as an event associated with the video data.

FIG. 2 shows a process of a birthday setting mode. The birthday setting mode is set by the operation of the operation unit 11. When the process is started, the event information processing unit 12 checks whether there is input of the birthday in step ST1. When there is input of the birthday, the event information processing unit 12 creates the typical event data by using the birthday as a starting point in step ST2, and registers the typical event data in the database held by the memory unit 13 in step ST3. In the database of the memory unit 13, the typical event data is managed in units of the birthday. A variety of events means events which occur in accordance with growth of a child from the birthday, such as, the first visit to a shrine, a festival of 3, 5, or 7 years of age, an entrance ceremony of a kindergarten or a school, athletics meets, a graduation ceremony of a kindergarten or a school, a trip and the like. To determine a specific event, it is necessary to examine the relation with the date and time of shooting, the shooting location, the place of residence and so on. Such an event is displayed as an icon image on the display unit 15. Therefore, icon image data for each event is also registered in the database. Additional events and icon images are obtainable as data downloaded from a website on the internet to a computer and transferred from the computer to the video camera with a cable connection, for example.

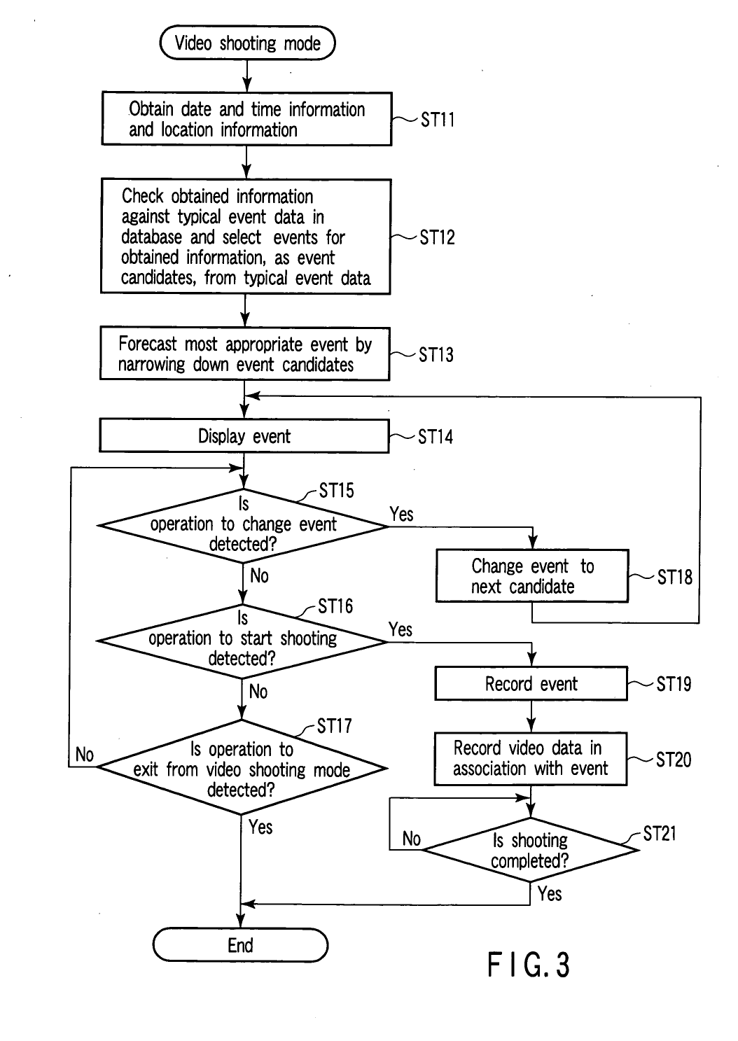

FIG. 3 shows a process of a video shooting mode. When the process is started by the operation of the operation unit 11, the event information processing unit 12 obtains date and time information (namely, year, month, day and time) and location information (namely, the current location and the place of residence) in step ST11. Then, the event information processing unit 12 checks the obtained information against the typical event data in database and selects events for the obtained information, as event candidates, from the typical event data in step ST12, and forecasts the most appropriate candidate by narrowing down the event candidates in step ST13. In this manner, when one candidate is determined to be the most appropriate event, the event is displayed as an icon image on the display unit 15 in step ST14. Step ST15 through step ST17 are repeatedly executed. Step ST15 is executed to check whether an operation to change the event is made. Step ST16 is executed to check whether an operation to start shooting is made. Then, step ST17 is executed to check whether an operation to exit from the video shooting mode is made. When the operation unit is operated to change the event, this operation is detected in step ST15, the event is changed to the next candidate in step ST18, and then, step ST14 is executed again. Further, when the operation to start shooting is detected in step ST16, the currently selected event is recorded in the hard disk 17 in step ST19, and then, the video data is recorded in the hard disk 17 in association with the event in step ST20. Here, on the condition that the event and the video data are associated with each other, the executing order of step ST19 and step ST20 may be reverse. The process of the video shooting mode ends when completion of the shooting is detected in ST21. Further, the video shooting mode ends also when the operation to exit from the video shooting mode is detected in step ST17.

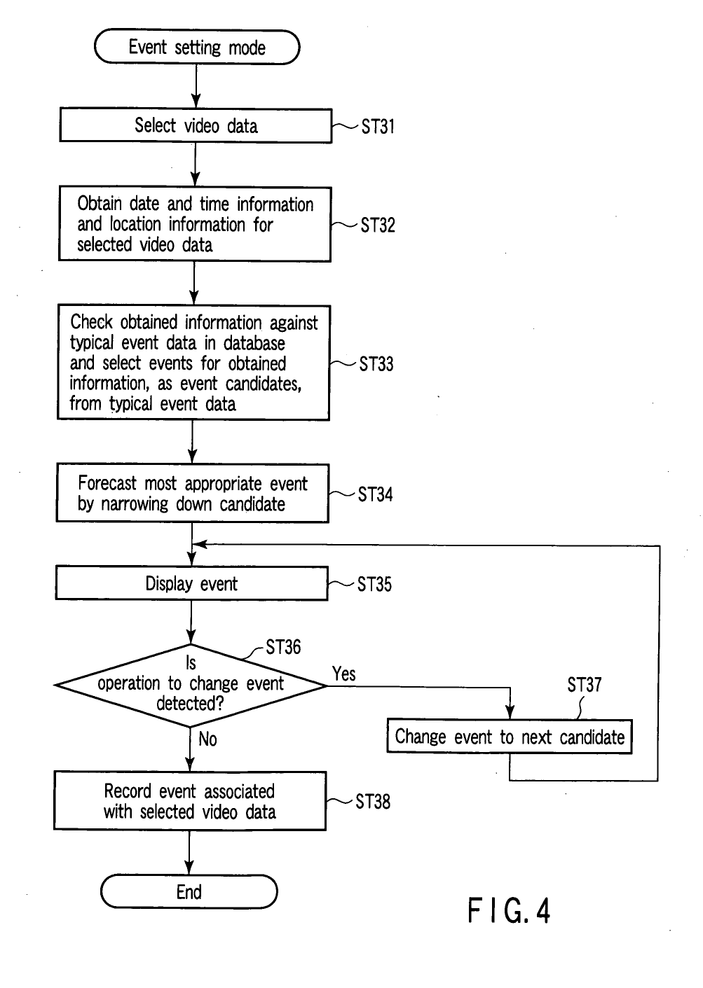

FIG. 4 shows a process of an event setting mode. The event setting mode is utilized when the video data is previously stored in the hard disk 17. When the process of the event setting mode is started by the operation of the operation unit 11, selection of the video data is made by the operation unit 11 in step ST31. When an event setting target is determined in this manner, the event information processing unit 12 obtains date and time information (namely, year, month, day and time) and location information (namely, the current location and the place of residence) in step ST32. Then, the event information processing unit 12 checks the obtained information against the typical event data in database and selects events for the obtained information, as event candidates, from the typical event data in step ST33, and forecasts the most appropriate candidate by narrowing down the event candidates in step ST34. When one candidate is determined to be the most appropriate event in this manner, the event is displayed as an icon image on the display unit 15 in step ST35. Then, in step ST36, it is checked whether an operation to change the event is made. When no operation to change the event is detected, the event is recorded to the selected video data in step ST38, and subsequently, the event setting mode ends. Further, when it is detected in step ST36 that the operation to change the event is made by the operation unit 11, the event is changed to the next candidate in step ST37, and step ST35 is executed again.

In this embodiment, in the case where the video shooting date is near the birthday, for example, the birthday event is assumed to be the most appropriate candidate among a variety of events included in the typical event data which is registered in the database. Further, as the child grows to be the age to enter a school and in the case where the video shooting date is April and the video shooting location is a school near the place of residence, a school entrance ceremony event is assumed to be the most appropriate candidate. At this time, it is also possible to display the message of “Is this a school entrance ceremony?” as the image instead of the icon. In the case where the video shooting is performed during a period corresponding to spring vacation, summer vacation or winter vacation of the child, and the location is away from the place of residence, a trip event is one of the event candidates. However, in the case where the location is the hometown of the parent and is registered as the specific spot, a coming hometown event is assumed to be the most appropriate candidate from the next time. In this manner, one event can appropriately be assumed among a variety of events in accordance with the growth of the child, by a selective combination of the location information of the video shooting location and the date and time of the video shooing from the GPS signals, the birthday of the child and the like.

As mentioned above, with the video camera, the typical event data including a variety of events is created by using the birthday input from the operation unit 11 as a starting point, and registered to the database. Events for at least the date and time of video shooting are selected as event candidates from the typical event data registered in the database. Further, the most appropriate candidate is forecasted by narrowing down the event candidates, and recorded in the hard disk 17, that is a recording medium, as an event associated with the video data. Namely, the event can be recorded without a burden. There is a case that the event which is actually recorded is inappropriate. In this case, the user may revise the record of the event as needed. However, since the total number of the inappropriate events is relatively small, the user does not have difficulty in finding a scene of interest without taking time even when the revision is not performed.

Here, the embodiment can be modified variedly within the scope of the invention.

To avoid apparent registering mistakes, step ST18 in FIG. 3 or in step ST37 in FIG. 4 may be modified into a form in which a candidate of “others” is selectable. In the step, the event may be changed in an interactive manner. In the step, a new typical event data other than the record of child's growth may be created and registered in the database.

Facility location information of a kindergarten, a school and the like, which are determined as being close by the location information of the place of residence, may be downloaded and registered in the memory unit 13 in the same manner as data of events and icon images.

With the abovementioned embodiment, a GPS processing unit 10 is provided to obtain the location information and the date and time information. However, in the case where the location information is omitted, a clock unit that determines the date and time may be provided instead of the GPS processing unit 10. In this case, the clock unit can be structured as a radio wave clock.

While certain embodiments of the inventions have been described, these embodiments have been presented by way of example only, and are not intended to limit the scope of the inventions. Indeed, the novel methods and systems described herein may be embodied in a variety of other forms. Furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video camera comprising:
an operation unit which performs a variety of input operations;
a video shooting unit which performs video shooting;
a recording unit which records video data obtained from the video shooting unit in a recording medium;
a clock unit which determines a date and time; and
an event information processing unit which creates typical event data including a variety of events by using a birthday input from the operation unit as a starting point, registers the typical event data in a database, selects events for at least the date and time of video shooting, as event candidates, from the typical event data registered in the database, forecasting a most appropriate candidate by narrowing down the event candidates, and recording the most appropriate candidate in the recording medium as an event associated with the video data.

2. The video camera according to claim 1, wherein the clock unit is a GPS processing unit which determines a current location where the video shooting is performed.

3. The video camera according to claim 2, wherein the event information processing unit is configured to reflect the current location obtained from the GPS processing unit in the forecasting to narrow down the event candidates.

4. The video camera according to claim 1, wherein the event information processing unit is configured to display the event candidate as an icon image.

5. The video camera according to claim 1, wherein the event information processing unit is configured to change the most appropriate candidate to another event candidate by an operation of the operation unit.

6. An event recording method of a video camera which comprises an operation unit which performs a variety of input operations, a video shooting unit which performs video shooting, a recording unit which records video data obtained from the video shooting unit in a recording medium, and a clock unit which determines a date and time, the method comprising:
creating typical event data including a variety of events by using a birthday input from the operation unit as a starting point;
registering the typical event data in a database;
selecting events for at least the date and time of video shooting, as event candidates, from the typical event data registered in the database;
forecasting a most appropriate candidate by narrowing down the event candidates; and
recording the most appropriate candidate in the recording medium as an event associated with the video data.

7. The event recording method according to claim 6, wherein the clock unit is a GPS processing unit which determines a current location where the video shooting is performed, and the current location is reflected in the forecasting to narrow down the event candidates.

8. The event recording method according to claim 6, wherein the event candidate is displayed as an icon image.

9. The event recording method according to claim 6, wherein the most appropriate candidate is changed to another event candidate by an operation of the operation unit.
